(19) United States
(12) Patent Application Publication
(10) Pub. No.: US 2024/0329744 A1
(43) Pub. Date: Oct. 3, 2024

(54) System And Device For Designing And Generating A Haptic Output

(71) Applicant: Sony Interactive Entertainment Europe Limited, London (GB)

(72) Inventors: Lewis Barn, London (GB); Christopher Buchanan, London (GB); Bee Lay Tan, London (GB)

(73) Assignee: Sony Interactive Entertainment Europe Limited, London (GB)

(21) Appl. No.: 18/617,174

(22) Filed: Mar. 26, 2024

(30) Foreign Application Priority Data
Mar. 27, 2023 (GB) GB2304419.1

(51) Int. Cl. G06F 3/01

(52) U.S. Cl. CPC G06F 3/016; G06F 3/014

(57) ABSTRACT

A system for designing and generating a haptic output, the system comprising: a user device for editing and generating a haptic control signal, the user device comprising a hand-operated input device for receiving user inputs to set one or more parameters of a haptic control signal and a processor configured to generate the haptic control signal based on the set parameters; and a haptic actuator device configured to provide a haptic output to the user via a contact surface according to the haptic control signal, wherein the haptic actuator device is arranged such that the contact surface is maintained in contact with the user's hand during use, while permitting movement of the user's hand to operate the input device.

### CROSS-REFERENCE TO RELATED APPLICATION

The present application claims priority from United Kingdom Patent Application No. GB2304419.1, filed Mar. 27, 2023, the disclosure of which is hereby incorporated herein by reference.

### FIELD OF THE INVENTION

The following disclosures relate to systems and devices for designing and generating a haptic output.

### BACKGROUND

A controller for a multimedia entertainment system is an input device that enables a user to provide input to the system. For example, the multimedia entertainment system may be a video game console and the controller enables a user to interact with a video game application running on the console.

The controller can also be an output device and provides feedback to the user in response to their operation of the controller and/or an event occurring on an application running on the multimedia entertainment system. The controller feedback can be provided in a variety of manners, such as audio feedback output from a speaker of the controller or haptic feedback output by a haptic module of the controller. Providing this controller feedback can substantially improve the experience of using the controller, for examples by deepening the immersion a user experiences, or by increasing the accessibility of the controller or an application being controlled.

Currently when designing the haptic feedback output for a controller, a designer is working at a computer to set the various parameters to the haptic vibration, such as duration, frequency, amplitude and panning. To experience the created haptic feedback in the same way that a user would experience it, the designer must press play and then pick up the controller. They are able to confirm if it is as intended and then can determine whether any further adjustments need to be made to the haptic output. Therefore, they are frequently switching back and forth between keyboard and controller which is inefficient and can lead to part of the haptic vibration being missed as they reach to pick up the controller.

### SUMMARY

It is an object of the present invention to provide systems for designing and generating a haptic output and to provide devices for providing haptic feedback during haptic design which makes progress in solving some of the problems identified above.

In a first aspect of the invention there is provided a system for designing and generating a haptic output, the system comprising: a user device for editing and generating a haptic control signal, the user device comprising a hand-operated input device for receiving user inputs to set one or more parameters of a haptic control signal and a processor configured to generate the haptic control signal based on the set parameters; and a haptic actuator device configured to provide a haptic output to the user via a contact surface according to the haptic control signal, wherein the haptic actuator device is arranged such that the contact surface is maintained in contact with the user's hand during use, while permitting movement of the user's hand to operate the input device.

The terms “designing” in relation to a haptic control signal may refer to the creating of a haptic control signal or the modifying of a pre-existing haptic control signal.

The term “permitting movement” may refer to unobstructed movement of the hand. The one or more parameters may be at least one of the rhythm, the volume, the sharpness (or pitch), the panning, the duration and the timbre (or texture) of the haptic output . . . . The parameters may be set by selecting audio data, for example an audio data file or a portion of an audio data file. In this way, the parameters of the audio date file, for example the frequency, amplitude, duration and/or panning, may be used to set the parameters of the haptic control signal. The parameters may also be set using a synthesiser to generate sounds, where parameters of the sounds are used to set one or more parameters of the haptic control signal. The haptic actuator device is preferably arranged such that the contact surface is maintained in contact with the user's hand during use, while permitting movement of the user's hand to operate the input device to perform one or more of the above methods of setting one or more parameters of the haptic control signal . . . . The hand-operated input device may be any peripheral device including may be a keyboard, a mouse, a mobile phone, a wearable device, or any device allowing the user to input information.

Advantageously, when designing or generating a haptic output, the designer is able to feel the haptic output produced by the control signal they are designing or generating without having to move from the peripheral device, for example, to pick up a controller. This improves the designing process by reducing unnecessary stopping to reach for a controller, while also preventing the designer from missing a part of the haptic vibration from reaching for the controller. Since the haptic actuator device is configured to provide a haptic output to the user via a contact surface according to the haptic control signal, the user will experience the haptic output in the same way a user handling a controller would. The haptic actuator device being maintained in contact with the user's hand during use, while permitting movement of the user's hand to operate the input device allows the designer to design and generate a haptic control signal for a prolonged period of time without stopping to pick up the controller.

Throughout the disclosure, the term “designer” refers to any user of the present invention, and may be used interchangeably with the term “user”.

In some examples, the haptic actuator device may be configured such that the contact surface is maintained in contact with one or both of: the user's palm and the back of the user's hand. Since the back of the user's hand stays substantially flat through movement of the hand during use of a hand-operated input device, it is advantageous to configure the haptic actuator device in this way to reduce the risk of lost contact between the contact surface and the hand through movement. Since a controller in normal use, for example during gameplay, is usually in contact with the palm of a user's hand, it is advantageous to configure the haptic actuator device on the palm of the user's hand so as to closer mimic the experience of the user with the controller.

In some examples, the haptic actuator device may be attachable so as to provide maintained contact between the contact surface of the haptic actuator device and the user's hand during use. Securing the device in place reduces the risk of the device moving or departing from the user's hand during use, thereby improving the efficiency of the design process.

In some examples, the haptic actuator device may be attachable to the user's hand while providing unobstructed movement of the user's fingers. Advantageously, this allows the user to interact with the hand-operated device without interference or obstruction from the haptic actuator device.

In some examples, the contact surface may comprise an adhesive surface configured to attach to the user's hand. This further improves the security of the device on the user's hand, thereby reducing the risk of the device moving or departing from the hand during use.

In some examples, the haptic actuator device may comprise a band arranged to extend from the user's palm around to the back of the hand during use. This further improves the security of the device on the user's hand, thereby reducing the risk of the device moving or departing from the hand during use.

In some examples, the system may comprise a first haptic actuator device configured to provide a haptic output to the user's left hand and a second haptic actuator device configured to provide a haptic output to the user's right hand. Advantageous as controllers are held with both hands during normal use, for example during gameplay, this system allows the designer to test how the user of a controller will experience the haptic output in each hand.

In some examples, the user device may be configured to provide a first haptic control signal to the first haptic actuator device and a second haptic control signal to the second haptic actuator device.

The first haptic control signal may be identical to the second haptic control signal such that the haptic actuator devices provide identical haptic output. This is advantageous as the designer is able to feel how the haptic output is experienced by both hands, and may be able to feel the haptic output better since it is being experienced by both hands rather than one.

The first haptic control signal may be different to the second haptic control signal such that the haptic actuator devices provide different haptic outputs. Some haptic outputs of a controller may be intended to only be felt by one hand, such that having a user device able to provide two different control signals to each haptic actuator device allows the system to provide different haptic outputs to each of the said haptic actuator devices so as to replicate the different haptic outputs of the controller during normal use.

In some examples, the haptic actuator device may form part of the hand-operated user input device. In this way, the designer is not required to move their hand once they have used the hand-operated user input device, thereby improving the efficiency of the design process.

In some examples, the hand-operated user input device may comprise a keyboard or mouse. Typically, these devices are used in the design process of a haptic output.

In some examples, the user device may be configured for designing a haptic output by the haptic actuator of a controller of a multimedia entertainment system and the haptic actuator device is configured to replicate characteristics of the haptic actuator of the controller.

In a second aspect of the invention there is provided a haptic actuator device for providing haptic feedback during haptic design, the haptic actuator device comprising: a contact surface arranged in contact with a user's hand during use; a haptic actuator configured to provide a haptic output through the contact surface according to a received haptic control signal; and wherein the haptic actuator device is configured to provide a maintained contact between the contact surface and the user's hand during use, while permitting movement of the user's hand to operate a hand-operated input device.

In some examples, the haptic actuator device may be configured to provide a maintained contact between the contact surface and the user's hand during use, while permitting movement of the user's hand to operate a keyboard or mouse.

In some examples, the haptic actuator device may be configured such that the contact surface is maintained in contact with one or both of: the user's palm and the back of the user's hand. Since the back of the user's hand stays substantially flat through movement of the hand during use of a hand-operated input device, it is advantageous to configure the haptic actuator device in this way since the contact surface in order to maintain contact between the contact surface and the hand through movement. Since a controller is usually in contact with the palm of a user's hand during normal use of a controller, for example during gameplay, it is advantageous to configure the device on the palm of the user's hand so as to closer mimic the experience of the user with the controller.

In some examples, the haptic actuator device may be attachable so as to provide maintained contact between the contact surface of the haptic actuator device and the user's hand during use. This further improves the security of the device on the user's hand, thereby reducing the risk of the device moving or departing from the hand during use

In some examples, the haptic actuator device may be attachable to the user's hand while providing unobstructed movement of the user's fingers. Advantageously, this allows the user to interact with the hand-operated device without interference or obstruction from the haptic actuator device.

In some examples, the contact surface may comprise an adhesive surface configured to attach to the user's hand. This further improves the security of the device on the user's hand, thereby reducing the risk of the device moving or departing from the hand during use.

In some examples, the haptic actuator device may comprise a band arranged to extend from the user's palm around to the back of the hand during use. This further improves the security of the device on the user's hand, thereby reducing the risk of the device moving or departing from the hand during use.

In some examples, the band may comprise at least one of: an elastic material; or two or more bands, wherein each band of the two or more bands is securable to at least another of the two or more bands.

In some examples, the haptic actuator device may comprise a glove configured for wear on at least a portion of the user's hand. Advantageously, the glove allows full movement of the user's hand while providing a haptic output which will provide an accurate representation to the designer of the haptic output felt by a user using a controller. The glove may comprise one or more actuators placed on an inside surface of the glove, one or more actuators on an outside surface of the glove, or one or more actuators integrated into the material of the glove. Each of the one or more actuators may be located at one or more positions on the glove.

In some examples, the haptic actuator device may comprise a keyboard, wherein the contact surface is provided by a palm rest arranged such that one or both of the user's palms lie on the palm rest during typing at the keyboard. Preferably, the palm rest is configured such that the user can rest their lower palm on the palm rest. Advantageously, this allows for unobstructed movement of a large portion of the user's hands and their fingers.

In some examples, the haptic actuator device may further comprise a device interface configured to receive at least one user indication relating to the haptic output. The device interface may include button(s) or a touch screen. For example, the device interface may receive an indication to switch the haptic actuator device off or on. The device interface may receive an indication to pause the haptic device or to continually provide the haptic output. The device interface may receive an indication relating to the strength of the haptic output and may include an indication to increase or decrease the strength of the output.

In some examples, the haptic actuator device comprises a haptic actuator that may be removable and replaceable. In this way, the user can use the same haptic actuator device to design the haptic outputs for a number of controllers by switching the haptic actuator that mimics a first controller with a haptic actuator that mimics a second controller.

### BRIEF DESCRIPTION OF DRAWINGS

FIG. 1 schematically illustrates an exemplary system according to an embodiment;

FIG. 2A schematically illustrates a plan view of a controller for a multimedia entertainment system;

FIG. 2B schematically illustrates a plan view of an exemplary haptic device for providing a haptic feedback output according to an embodiment;

FIGS. 3A and 3B schematically illustrate the exemplary haptic device in a first and a second configuration respectively;

FIG. 4A schematically illustrates a partial exemplary system comprising a first haptic device and a second haptic device, both in a first configuration;

FIG. 4B schematically illustrates a partial exemplary system comprising the first haptic device and the second haptic device, both in a first configuration and in use;

FIG. 5 schematically illustrates a plan view of an exemplary haptic device for providing a haptic feedback output according to an embodiment;

FIG. 6 schematically illustrates a plan view of an exemplary haptic device for providing a haptic feedback output according to an embodiment;

FIG. 7 schematically illustrates a plan view of an exemplary haptic device for providing a haptic feedback output according to an embodiment.

### DETAILED DESCRIPTION

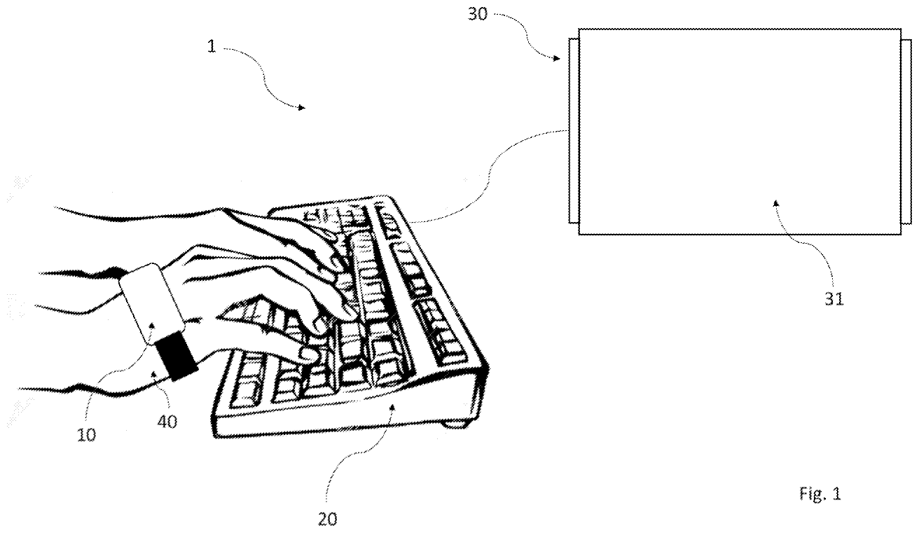

FIG. 1 schematically illustrates an exemplary system 1 according to an embodiment of the present invention.

The system 1 for designing and generating a haptic output comprises a user device. The user device includes at least one processor which is included as a component of a computer 30. The at least one processor may be at least one of a central processing unit (CPU) or a graphic processing unit (GPU). The computer 30 also includes a memory and is coupled to a display screen 31 via a wired or a wireless connection. In some examples, the display screen 31 and the computer 30 may be combined in a single device, as is shown in FIG. 1.

In some examples, the computer 30 is configured to run software capable of designing and generating a haptic output of a given output device, such as a controller. The computer 30 may be configured to run various programming languages, in particular these includes programming languages specific to designing haptic control signals.

The system 1 comprises a hand-operated input device 20 for receiving user inputs to set one or more parameters of a haptic control signal. In this way, the designer may interface with the computer 30 through the hand-operated input device 20. Exemplary parameters of the haptic control signal include the rhythm, the volume, the sharpness (or pitch) and the timbre (or texture) of the haptic output signal . . . . The processor of the computer 30 is configured to generate the haptic control signal based on the set parameters.

In some examples, haptics can be created by using or modifying existing audio assets, each having one or more pre-set parameters. The existing audio assets may be sounds in a library or database of sound effects or music. The pre-set parameters, e.g. the frequency, amplitude, duration and panning of the existing audio assets characterise the haptic output signal.

The display screen 31 may display, to the designer, a means of changing the pre-set parameters of the haptic control signal. For example, display screen 31 may present the designer with a number of design options for the haptic control signal. Each option may represent a given parameter of the haptic design signal that can be selected by the designer using the hand-operated input device 20. For example, icon(s) corresponding to a given parameter of the pre-set parameters may be displayed to the designer on the display screen 31, to which the designer can use the hand-operated input device 20 to select, change or modify the given pre-set parameter. Each icon may relate to a discrete value for the given parameter, alternatively, the icon may be a continuous slider for the given parameter.

In some examples, the system 1 may comprise or be in communication with a synthesiser such that the designer can generate new sounds, and therefore new haptic control signals, using the said synthesiser. The sounds created using the synthesiser will have parameters which determine the haptic output signal.

In other examples, if the designer is using coding software to design or generate the haptic control signal, a terminal is displayed on the display screen 31. The designer can then use the hand-operated input device 20 to type or input text-based commands. The processor will generate the haptic control signal based on this input from the set parameters input by the designer.

In FIG. 1, the hand-operated input device 20 is a keyboard. Advantageously, a keyboard allows a designer to type text-based commands when designing or generating the haptic control signal. This gives the designer a high degree of freedom in the parameters they may input. In other examples, the hand-operated input device 20 is a mouse. Advantageously, the designer can use the mouse to make selections of the parameters displayed on the display screen 31.

Other examples of the hand-operated input device 20 include a touch screen interface, a handheld controller, an audio headset or audio-visual headset (e.g. VR or AR headsets), a mobile phone, a wearable device, or any device allowing the designer to set one or more parameters.

The system 1 may further comprise more than one hand-operated input device 20. For example, the designer may use a keyboard to type text-based commands, and then may then use a mouse to make additional edits to the haptic control signal or to confirm they are finished editing the haptic control signal.

A designer may use the above-described hand-operated input device 20, computer 30 and display screen 31 to design and generate haptic control signals for a controller for a multimedia entertainment system. Once the designer has finished generating or editing the haptic control signal intended for the haptic module of a controller, they will have to remove their hands from the hand-operated input device 20 to pick up the controller in order to experience the haptic output from the perspective of a user of the controller. This is inefficient and may cause the designer to miss the start of the haptic output while switching between devices.

As such, the system 1 further comprises a haptic actuator device 10 configured to provide a haptic output to the user according to the generated haptic control signal. The haptic output is provided via a contact surface 11 of the haptic actuator device 10. The haptic actuator device 10 is arranged such that the contact surface 11 is maintained in contact with the designer's hand 40 during use, while permitting movement of the designer's hand to operate the hand-operated input device 20.

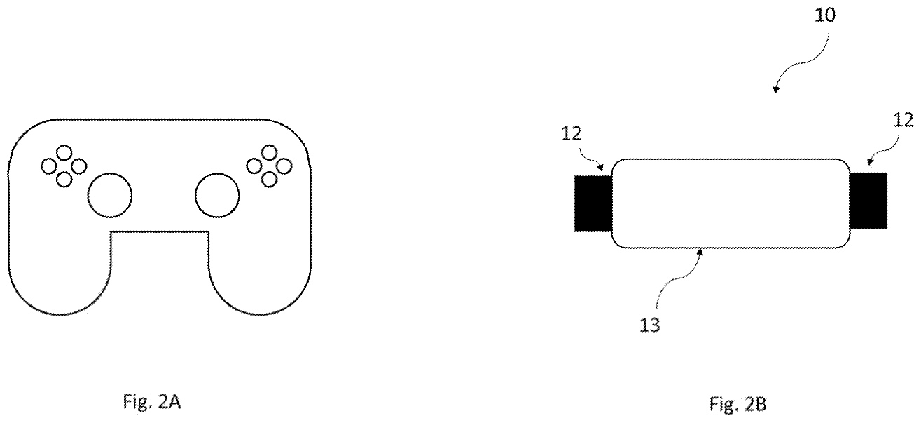

FIG. 2A shows an exemplary controller 100 for a multimedia entertainment system. In some examples, the controller 100 is a PlayStation controller. The controller 100 comprises a singular haptic module. Alternatively, the controller 100 comprises several haptic modules which can be distributed across the controller 100. In some examples, the haptic module(s) comprise a vibration engine actuator, wherein the haptic output is a vibration. The vibration engine actuator may be configured to cause vibrations by comprising a component configured to spin at different speeds and durations. Other types of haptic modules may instead or additionally be included in the controller 100, for example and may be a voice-coil or a weighted rotatory component.

FIG. 2B shows a haptic actuator device 10 intended to provide a haptic output that mimics that of the above-described controller 100. In this example, the user device is configured for designing a haptic output by the haptic actuator of a controller of a multimedia entertainment system and the haptic actuator device 10 is configured to replicate characteristics of the haptic actuator of the controller 100.

For example, when the controller 100 comprises a haptic module with a vibration engine actuator, the haptic actuator device 10 also comprises a vibration engine actuator identical to that of the controller 100. In other examples, the haptic actuator device 10 may not be identical to the haptic module of the controller 100, but may still be configured to output an identical haptic output to that of the haptic module of the controller 100.

In some examples, the haptic actuator device 10 has the same weight as the of the controller 100. This allows the haptic output, such as a vibration, to mimic more closely the vibrations felt by a user when using the controller 100. In another example, the weight of the haptic actuator device 10 may be adjustable since different types of controllers 100 have different haptic modules, and different weights, thereby providing different haptic outputs. In some examples, the haptic actuator device comprises a haptic actuator that is removable and replaceable, and may be replaced with another haptic actuator. Advantageously, this allows the haptic actuator device 10 to mimic the haptic outputs of more than one controller 100.

As mentioned above, the haptic actuator device 10 is arranged such that the contact surface 11 is maintained in contact with the designer's hand during use, for example, during the process of designing the haptic control signal. In this way, the designer will feel the haptic output that a user of the controller will experience through their hand.

There are a number of ways that the haptic actuator device 10 can be configured to provide a maintained contact between the first contact surface 11 and the designer's hand during use, while permitting movement of the designer's hand to operate a hand-operated input device 20.

In one example, the haptic actuator device 10 may be a rectangular cuboidal shape as shown in FIG. 2B. The contact surface 11 of the haptic actuator device 10 is located at one of the faces of the rectangular cuboid. A contact surface 11 being substantially flat allows for a substantial portion, if not all, of the contact surface 11 to be in contact with the either a back of the user's hand of the designer's hand or on a palm of the designer's hand. This optimises the amount of the haptic output felt by the designer.

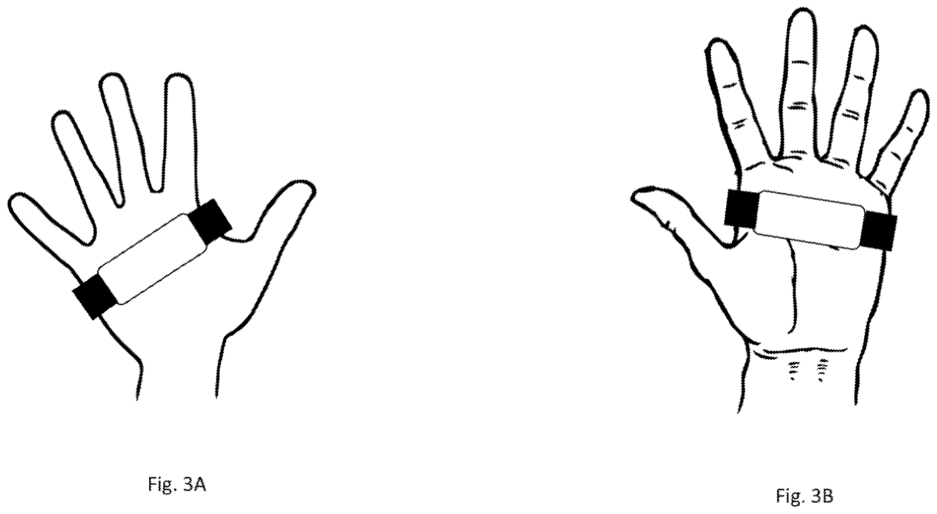

FIG. 3A shows an embodiment of the present invention wherein the haptic actuator device 10 is configured such that the contact surface 11 is maintained in contact with the back of the designer's hand 40. In examples where the contact surface 11 is substantially flat, the contact surface 11 can be arranged to lie parallel to a plane of the back of the design's hand 40. In this way, a substantial portion, if not all, of the contact surface 11 is in contact with the back of the designer's hand 40 since the back of a designer's hand 40 may be largely considered as a flat surface. As such, the designer is able to feel the haptic vibrations through a substantial portion of the back of their hand 40. In some examples, as shown in FIG. 3A, the haptic actuator device 10 is attachable to the user's hand while providing unobstructed movement of the user's fingers.

FIG. 3B illustrates an embodiment of the present invention wherein the haptic actuator device 10 is configured such that the contact surface 11 is maintained in contact with the palm of the designer's hand 40. Similarly to above, a substantial portion of the contact surface 11 is in contact with the palm of the designer's hand 40. Advantageously, this arrangement will allow the designer to experience a haptic output on the palm of their hand 40 similar to that experienced by a user's palm when they are gripping a controller 100.

In some examples, the haptic actuator device 10 is configured such that the contact surface 11 is maintained in contact with both of the user's palm and the back of the user's hand.

Any other suitable shape for a haptic actuator device 10 is contemplated. For example, the haptic actuator device 10 may be shaped so as to maximise the contact between at least a portion of the designer's hand 40 and the contact surface 11. For example, the contact surface 11 may be malleable such that it adapts to the specific shape and/or size of the given designer's hand 40. Alternatively, the haptic actuator device 10 may be custom-made using the anthropometric measurements of the given designer's hand 40.

In some examples, the haptic actuator device 10 comprises a device interface configured to receive at least one user indication relating to the haptic output. For example, the designer may which to set a number of parameters before using the haptic actuator device 10 to feel the designed haptic output. In this way, the haptic actuator device 10 may comprise a device interface which allows the designer to switch off, switch on or pause the haptic output. Additionally, for a haptic actuator device 10 with variable strength of haptic output, the design interface may be used by the designer to increase or decrease the strength of the vibration outputted by the haptic actuator device 10.

In some examples, the haptic actuator device 10 is attachable so as to provide maintained contact between the contact surface 11 of the haptic actuator device 10 and the designer's hand 40 during use. For example, the haptic actuator device 10 is attachable to the designer's hand while providing unobstructed movement of the designer's fingers. In some examples, the contact surface 11 comprises an adhesive surface configured to attach to the designer's hand 40.

In some examples, as shown in FIGS. 2B, 3A and 3B and 4A and 4B, the haptic actuator device 10 may comprise a band 12 arranged to extend from the designer's palm around to the back of the hand 40 during use. When the haptic actuator device 10 is rectangular cuboidal in shape, the band 12 may extend from opposed sides of the haptic actuator device 10, forming a continuous loop shaped to extend around the designer's hand 40. The measurements of the loop may be based on average hand measurements of a sample of user's or may be customised to the given designer's hand 40.

The band 12 may comprise an elastic material. In this way, the circumference of the loop can stretch and adjust to the given hand shape and/or size of the designer. Alternatively, the band 12 may comprise an adjustable fastener which the designer can use to secure the band loop around their hand 40. Alternatively, the band 12 may comprise two or more bands, wherein each band of the two or more bands is securable to at least another of the two or more bands. The two or more bands may be arranged at opposed ends of the haptic actuator device 10. The bands may be releasably fastened using fastening elements to allow for attachment of one or more bands to one another of the one or more bands, so as to form a loop once fastened. Such fastening elements may include Velcro or stud fasteners, or any other suitable means of fastening.

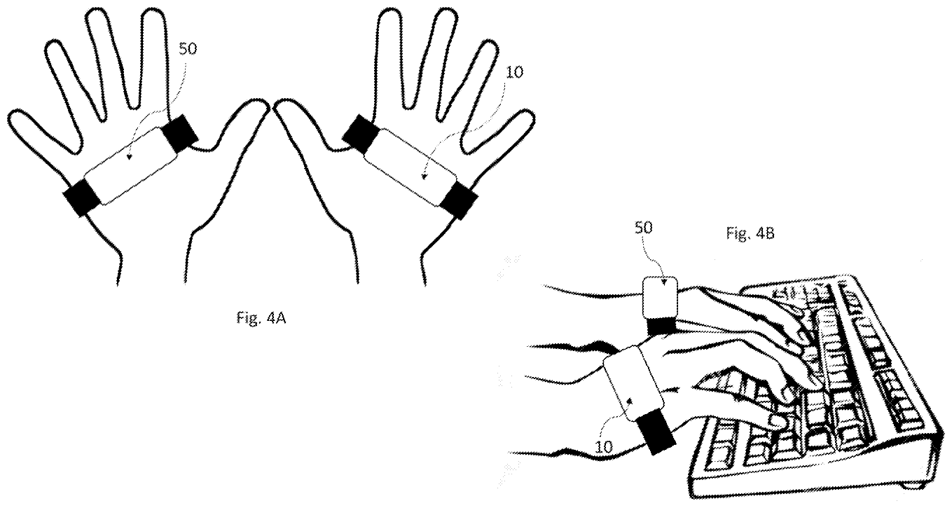

FIGS. 4A and 4B show an exemplary the system 1 comprising a first haptic actuator device 10 configured to provide a haptic output to the designer's left hand and a second haptic actuator device 50 configured to provide a haptic output to the designer's right hand. FIG. 4B shows the first haptic device 10 and the second haptic device 50 arranged on each respective hand of the designer when the system 1 is in use. As demonstrated by FIG. 4B, the first haptic device 10 and the second haptic device 50 are arranged on each of the designer's hands so as to allow for movement of each hand while using the hand-operated input device 20 (i.e. the keyboard).

In some examples, the user device is configured to provide a first haptic control signal to the first haptic actuator device 10 and a second haptic control signal to the second haptic actuator 50. The first control signal can be identical to the second control signal. In examples wherein the second haptic actuator device 50 is identical to the first haptic actuator device 10 and where the respective control signals are identical, then the haptic outputs will also be identical. In this way, the designer feels the same haptic output on each hand via each said haptic actuator device.

In examples where the first haptic actuator device 10 is identical to the second haptic actuator device 50, the second haptic device 50 may comprise an identical actuator(s) configured to provide identical haptic output(s) to those outputted by the actuator(s) in the first haptic device 10. In some examples, the first haptic device 10 is a reflected duplicate of the second haptic device 50, or vice versa such that they are configured for wear and use on each hand.

Alternatively, the user device is configured to provide a first haptic control signal to the first haptic actuator device and a second haptic control signal to the second haptic actuator device, wherein the first haptic control signal is different to that of the second haptic control signal. In this way, each haptic actuator device 10, 50 may provide a different haptic output. For example, the first haptic device 10 may provide a haptic output corresponding to an actuator located on a left side of the controller 100, while the second haptic device 50 may provide a haptic output corresponding to a different actuator located on the right side of the controller 100.

In other examples, each haptic device 10, 50 may provide a haptic output corresponding to a different controller 100. The first haptic device 10 may provide a haptic output corresponding to a controller A, while the second haptic device 50 may provide a haptic output corresponding to a controller B. Advantageously, the designer may design or generate control signals for two controllers, A and B, within a given period without having to remove and replace the haptic device(s) 10, 50 from their hand.

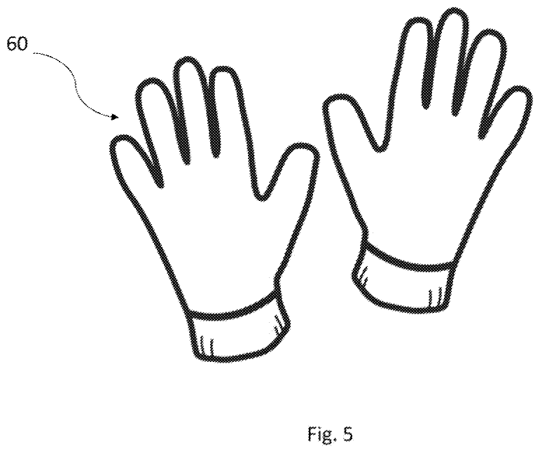

FIG. 5 shows an embodiment of wherein the haptic actuator device 10 comprises a glove configured for wear on at least a portion of the designer's hand 40. The haptic actuator device 10 may comprise actuator(s) placed on an inside surface of the glove 60, on an outside surface of the glove 60, or integrated into the material of the glove 60. The glove 60 may comprise more than one actuator, which may each be located at one or more positions on the glove 60. In examples wherein the system 1 comprises a first haptic actuator device 10 and a second haptic actuator device 50, the first haptic actuator device 10 is a left-handed glove and the second haptic actuator device 10 is a right-handed glove. The actuator(s) of each haptic device 10, 50 may be configured in the same way or may be different, as described above in relation to FIGS. 4A and 4B.

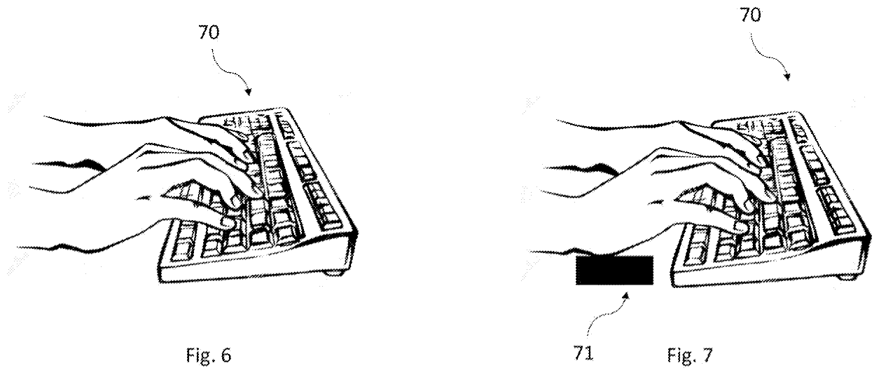

FIG. 6 illustrates an exemplary embodiment of the present invention wherein the haptic actuator device 10 is the hand-operated input device. As shown in FIG. 7, the hand-operated input device is a keyboard 70. In some examples, the haptic actuator device 10 is configured to provide a haptic output to the user via a contact surface 11, which is located on one or more of the keys of the keyboard 70. Additionally or alternatively, the haptic actuator device 10 is located at any other portion of the keyboard 70.

FIG. 7 illustrates an embodiment of the present invention in which the haptic actuator device 10 comprises a keyboard 70, wherein the contact surface 11 is provided by a palm rest 71 arranged such that one or both of the user's palms lie on the palm rest during use, for example during typing at the keyboard 70. In some examples, there the first haptic device 10 comprises more than one palm rest 71.

Preferably, the designer can rest their lower palm on the first surface 11. Advantageously, the designer can choose when the rest their lower palm on the first haptic device 10, and when to remove it during the design process. In other examples, the palm rest 71 may be position on or proximal to a mouse or mouse matt. The designer may then use the mouse to input information to the user device before or during resting at least a portion of their palm on the first surface 11.

1. A system for designing and generating a haptic output, the system comprising:
a user device for editing and generating a haptic control signal, the user device comprising:
a hand-operated input device for receiving user inputs to set one or more parameters of a haptic control signal; and
a processor configured to generate the haptic control signal based on the set parameters; and
a haptic actuator device configured to provide a haptic output to the user via a contact surface according to the haptic control signal, wherein the haptic actuator device is arranged to maintain that the contact surface is in contact with a hand of the user during use while permitting movement of the hand of the user to operate the input device.

2. The system according to claim 1, wherein the haptic actuator device is configured to maintain the contact surface in contact with one or both of a palm of the user or a back of the hand of the user.

3. The system according to claim 2, wherein the haptic actuator device comprises a band arranged to extend from the palm around to the back of the hand during use.

4. The system according to claim 1, wherein the haptic actuator device is attachable to provide maintained contact between the contact surface of the haptic actuator device and the hand of the user during use.

5. The system according to claim 1, wherein the haptic actuator device is attachable to the hand of the user while providing unobstructed movement of the fingers of the user.

6. The system according to claim 1, wherein the contact surface comprises an adhesive surface configured to attach to the hand of the user.

7. The system according to claim 1, wherein the haptic actuator device comprises a first haptic actuator device configured to provide a haptic output to a left hand of the user and a second haptic actuator device configured to provide a haptic output to a right hand of the user.

8. The system according to claim 7, wherein the user device is configured to provide a first haptic control signal to the first haptic actuator device and a second haptic control signal to the second haptic actuator device.

9. The system according to claim 1, wherein the haptic actuator device forms part of the hand-operated input device.

10. The system according to claim 1, wherein the hand-operated input device comprises at least one of a keyboard or mouse.

11. The system according to claim 1, wherein:
the user device is configured for designing a haptic output by a haptic actuator of a controller of a multimedia entertainment system; and
the haptic actuator device is configured to replicate characteristics of the haptic actuator of the controller.

12. A haptic actuator device for providing haptic feedback during haptic design, the haptic actuator device comprising:
a contact surface arranged in contact with a hand of a user during use; and
a haptic actuator configured to provide a haptic output through the contact surface according to a received haptic control signal;
wherein the haptic actuator device is configured to provide a maintained contact between the contact surface and the hand during use while permitting movement of the hand to operate a hand-operated input device.

13. The device according to claim 12, wherein the haptic actuator device is configured to provide a maintained contact between the contact surface and the hand during use while permitting movement of the hand to operate at least one of a keyboard or mouse.

14. The device according to claim 12, wherein the haptic actuator device is configured to maintain the contact surface in contact with one or both of a palm of the user or a back of the hand of the user.

15. The device according to claim 12, wherein the haptic actuator device is attachable to provide maintained contact between the contact surface of the haptic actuator device and the hand during use.

16. The device according to claim 12, wherein the haptic actuator device is attachable to the hand while providing unobstructed movement of fingers of the user.

17. The device according to claim 12, wherein the contact surface comprises an adhesive surface configured to attach to the hand.

18. The device according to claim 12, wherein the haptic actuator device comprises a band arranged to extend from a palm of the user around to a back of the hand during use.

19. The device according to claim 18, wherein the band comprises at least one of:
an elastic material; or
two or more bands, wherein each band of the two or more bands is securable to at least another of the two or more bands.

20. The device according to claim 12, wherein the haptic actuator device comprises a glove configured for wear on at least a portion of the hand.

21. The device according to any of claim 12, further comprising a keyboard, wherein the contact surface is provided by a palm rest arranged such that one or both palms of the user lie on the palm rest during typing at the keyboard.

22. The device according to claim 12, further comprising a device interface configured to receive at least one user indication relating to the haptic output.

23. The device according to claim 12, wherein the haptic actuator is removable and replaceable.
